(19) United States
(12) Patent Application Publication
(10) Pub. No.: US 2026/0351742 A1
(43) Pub. Date: Nov. 5, 2026

(54) LID ASSEMBLY FOR A PRISMATIC BATTERY CELL AND METHOD FOR PRODUCING SUCH LID ASSEMBLY

(71) Applicant: FREUDENBERG SEALING TECHNOLOGIES S.A.S. DI EXTERNA ITALIA S.R.L.U., PINEROLO (TO) (IT)

(72) Inventors: Alessandro BOI, PINEROLO (TO) (IT); Loubna BARGHOUT, WEINHEIM (DE); Cristoph KLINGSHIRN, EPPELHEIM (DE); Ingo STEPHAN, RIMBACH (DE); Björn HELLBACH, BIRKENAU (DE); Peter KRITZER, FORST (DE)

(73) Assignee: FREUDENBERG SEALING TECHNOLOGIES S.A.S. DI EXTERNA ITALIA S.R.L.U., PINEROLO (TO) (IT)

(21) Appl. No.: 19/488,288

(22) PCT Filed: Jun. 6, 2023
(86) PCT No.: PCT/IB2023/055795

§ 371 Date: Nov. 26, 2025

(51) Int. Cl. H01M 50/15; H01M 50/103; H01M 50/188; H01M 50/474; H01M 50/486; H01M 50/55; H01M 50/557

(52) U.S. Cl. CPC H01M 50/15; H01M 50/103; H01M 50/188; H01M 50/474; H01M 50/486; H01M 50/55; H01M 50/557

(57) ABSTRACT

There is described a lid assembly (1) for a prismatic battery cell comprising: a base plate (4); a current collector (55) electrically connectable to a respective electrode of the battery cell, for collecting electrical energy; a terminal (6) electrically coupled with the current collector (5) for receiving the electrical energy therefrom; and an insulator member (7) interposed between the terminal (6) and the base plate (4) for electrically insulating the terminal (6) from the base plate (4); the insulator member (7) has an inner portion (7b) and an outer skin (7a) surrounding the inner portion (7b) and defining an external surface thereof; at least one among the inner portion (7b) of the insulator member (7), the terminal (6) and the base plate (4) includes at least one protrusion (13) projecting therefrom for piercing the outer skin (7a), respectively from the inside or from the outside thereof.

### TECHNICAL FIELD

The present invention relates to a lid assembly for a prismatic battery cell, in particular a lid assembly for closing and sealing in a fluid-tight manner an inner compartment of a prismatic battery cell housing electrodes and electrolytic material.

The present invention also relates to a method for producing a lid assembly for a prismatic battery cell of the aforementioned type.

### BACKGROUND ART

Battery cells are known, which are used as electrical energy accumulators.

In particular, so-called primary batteries are known, which cannot be easily recharged and are therefore destined to single-use, and so-called secondary batteries are known, which can be repeatedly charged after each cycle of usage.

Single-cell batteries of the secondary type are known which are used for various portable small-sized electronic devices, such as cellular phones, watches, smartwatches, smartbands, etc.

Also batteries which include a plurality of cells connected in series or in parallel are known, for example as used in the automotive industry.

The present invention will refer to a battery cell for the use in a battery of a hybrid or full-electric vehicle, without however losing generality.

Secondary battery cells can be manufactured as various types, such as cylindrical or prismatic cells.

The present invention will refer to prismatic battery cells, without however losing generality.

A prismatic battery cell typically comprises a hollow prismatic casing, for example in the shape of a parallelepiped and usually made of metallic material, generally open on at least one side (for example on the top) and a lid assembly for closing the casing.

The casing defines an inner compartment of the cell and houses two electrodes (cathode and anode), which are provided for example in the form of sheets, and a separator material electrically interposed between the two electrodes.

Within the compartment, the electrodes and the separator are immersed in an electrolytic solution, usually liquid or gelatinous.

The lid assembly is coupled to the casing at an opening thereof for closing the inner compartment, thereby maintaining electrodes and separator in place and preventing the outflow of the electrolytic solution.

The lid assembly essentially comprises:
a base plate, typically made of metallic material such as aluminum, arranged to match and engage the opening of the casing for the closing thereof;
one current collector for each electrode, which is electrically connected to the relative electrode and is configured to collect the electric energy from such electrode and feed it from the inner compartment towards the outside environment; and
a terminal for each electrode, which is electrically connected with the respective collector for receiving the electric energy therefrom, and which is configured to receive a connector of a consumer device which has to be powered by the battery cell.

The terminal is arranged on an outer side of the base plate, and the collector s arranged, at least partially, on an inner side of the base plate (i.e. the side facing the inner compartment).

The terminal is fitted to a pin portion of the collector which passes through a hole in the base plate.

A typical lid assembly also comprises an insulator member for each terminal, which is interposed between the relative terminal and the base plate for electrically insulating the terminal from the base plate.

Thanks to the presence of the insulator member, a direct electric connection between each terminal and the base plate, which would be dangerous and detrimental to the correct functioning of the battery cell, is avoided.

In light of the above, the lid assembly includes two terminal groups, each comprising one terminal, one collector, one insulator member.

Typically, each terminal group has an axial development from the inner compartment towards the outside environment.

During assembly of the battery cell, the components of each terminal group are axially stacked, compressed and welded together.

It is known in the field the need for preventing a complete (total) electric insulation between one of the terminals, and in particular the cathode, and the base plate. In other words, a 100% electrical insulation between the cathode terminal and the base plate is undesirable, since such complete electrical insulation may result in an excessive electrical charging (“parasitic currents”) of the battery cell. This excessive charging may lead to what is known as “electro-static damage” or ESD, which is highly detrimental to the functioning and lifespan of the battery cell.

To this end, the insulator member of such terminal (cathode), which is usually made of rigid thermoplastic material, may be designed to be slightly conductive, for example with an electric resistance of 100 to 10000 ohm. The parasitic currents which build up at the cathode terminal may therefore be discharged via such slightly conductive insulator member.

The Applicant has observed that the known lid assemblies are still open to further improvement, in particular as per the electric connection between the (cathode) terminal and the base plate.

More in particular, the Applicant has observed that there are three main phenomena which negatively influence the desired conductivity of the insulator member:
unevenness of the interfaces between the components of the terminal group may lead to relatively large axial gaps (at micro scale), which in turn may lead to an increase in electric resistance between the components;
production-related shape and position tolerances, and also shrinkage and distortion of the plastic insulator member, may lead to air gaps between the aforementioned interfaces, which further increase the electric resistance and decrease the desired conductivity, thereby hindering the discharge of the parasitic currents;
the insulator member is usually obtained by injection molding; such process determines the creation of a sort of skin which defines the external surface of the insulator member; such skin can have a density different from the density of the rest of the insulator member, which can undesirably increase the electric resistance therethrough.

### Disclosure of Invention

It is therefore an object of the present invention to provide a lid assembly for a prismatic battery cell which is designed to overcome at least one of the above-mentioned drawbacks in a straightforward and low-cost manner.

This object is achieved by a lid assembly as claimed in claim 1.

It is a further object of the present invention to provide a method for producing a lid assembly for a prismatic battery cell mentioned drawbacks in a straightforward and low-cost manner.

This object is achieved by a method for producing a lid assembly as claimed in claim 15.

### BRIEF DESCRIPTION OF THE DRAWINGS

A non-limiting embodiment of the present invention will be described by way of example with reference to the accompanying drawings, in which:

FIG. 1 is a partially sectioned exploded view, with parts removed for clarity, of a lid assembly for a prismatic battery cell according to the present invention;

FIGS. 2a and 2b are a larger-scale, sectioned side view, with parts removed for clarity, of the lid assembly of FIG. 1 showing a terminal group according to a first preferred embodiment of the invention, respectively in disassembled and assembled conditions;

FIG. 3 is a larger-scale, sectioned side view, with parts removed for clarity, of the lid assembly of FIG. 1 showing a terminal group according to a second preferred embodiment of the invention;

FIG. 4 is a larger-scale, sectioned side view, with parts removed for clarity, of the lid assembly of FIG. 1 showing a terminal group according to a third preferred embodiment of the invention; and

FIG. 5 is a larger-scale, sectioned side view, with parts removed for clarity, of the lid assembly of FIG. 1 showing a terminal group according to a further preferred embodiment of the invention.

### BEST MODE FOR CARRYING OUT THE INVENTION

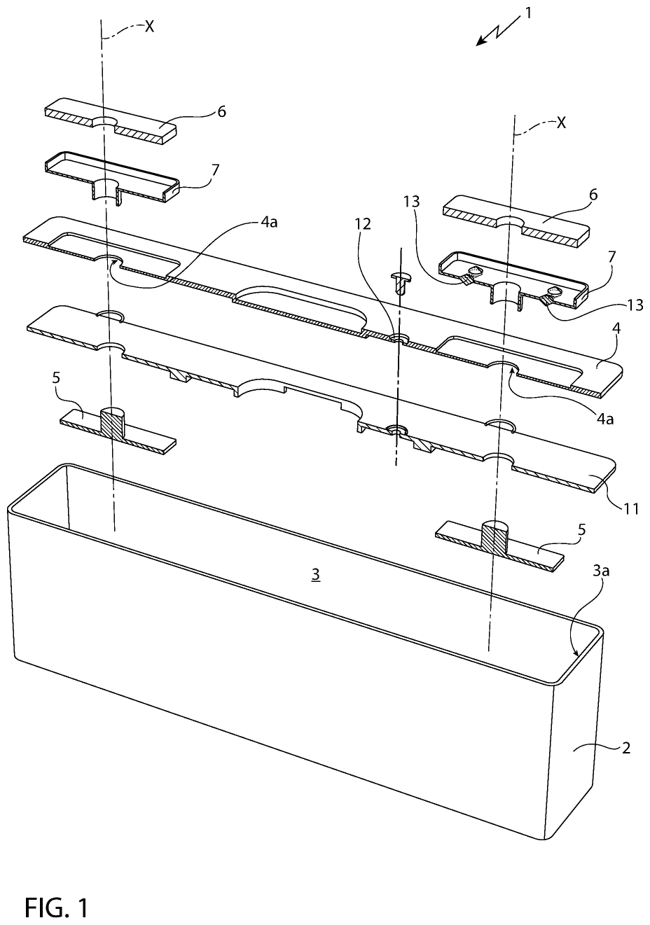

With reference to FIG. 1, number 1 indicates as a whole a lid assembly for a prismatic battery cell.

In particular, the battery cell is of the prismatic type and has a hollow prismatic casing 2 which internally defines an inner compartment 3 with an opening 3a to access inner compartment 3.

The battery cell further comprises electrodes (cathode and anode, not shown), which are housed in inner compartment 3 together with a separator material (not shown) and an electrolytic solution (not shown).

The electrodes and the separator material are inserted into inner compartment 3 from opening 3a.

Accordingly, lid assembly 1 is configured to be coupled with casing 2 at opening 3a for fluid-tightly closing inner compartment 3, as required during the normal use of the battery cell.

Hence, the battery cell comprises casing 2, with the electrodes, the separator and the electrolytic solution, and lid assembly 1.

According to the embodiment shown, casing 2 has a parallelepiped shape. However, casing 2 may have any prismatic shape, such as cubic, triangular-based, etc.

In one embodiment, casing 2 may be cylindrical.

The present invention will refer to a prismatic battery cell, without however losing generality.

In particular, the present invention will refer to a battery cell for use in the automotive industry, for example in a battery module of a hybrid or full-electric vehicle, without however losing generality.

As shown in FIG. 1, lid assembly 1 essentially comprises:
a base plate 4, made of metallic material, preferably aluminum, for closing opening 3a of inner compartment 3, namely arranged to match the shape of, and engage, opening 3a for closing inner compartment 3;
at least one, and in particular two current collectors 5 each electrically connectable to the respective electrodes of the battery cell for collecting electrical energy therefrom and transferring it from inner compartment 3 outwards;
at least one, and in particular two terminals 6, each electrically coupled with one respective collector 5 for receiving the electrical energy therefrom, and each configured to receive a respective connector (not shown) of a consumer device (not shown) which is to be powered by the battery cell; and
at least one, and in particular two insulator members 7, each interposed between one respective terminal 6 and the base plate 4 for electrically insulating such terminal 6 from base plate 4.

Each terminal 6 is configured to be electrically connected to one respective electrode, that is one terminal 6 is connectable with the anode and the other terminal 6 is connectable with the cathode.

In FIG. 1, the left-hand side terminal 6 is the anode terminal and the right-hand side terminal 6 is the cathode terminal.

In light of the above, lid assembly 1 comprises a pair of terminal groups 8, namely an anode terminal group 8 and a cathode terminal group 8.

Each terminal group 8 incudes one collector 5, one terminal 6 and one insulator member 4.

The present invention concerns the cathode terminal group 8, and therefore reference will be made in the following to the cathode terminal group 8 and the components thereof.

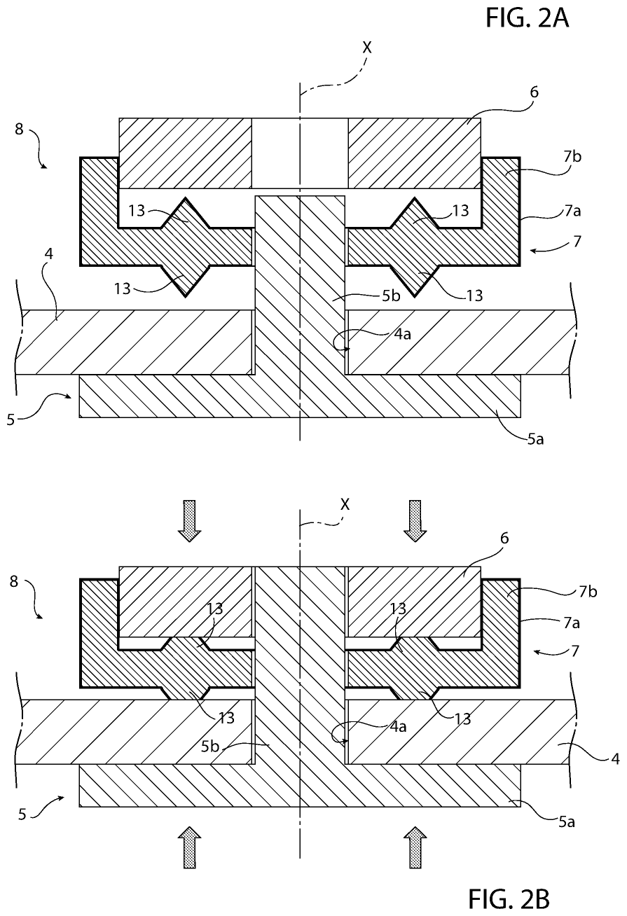

With reference to FIGS. 1, 2a and 2b, terminal group 8 has a central axis X.

Preferably, collector 5 includes a plate body 5a for electric connection with the respective electrode and a pin 5b which has a substantially cylindrical shape and extends from plate body 5a, preferably orthogonally, even more preferably axially (and particularly along axis X).

Base plate 4, terminal 6, collector 5 and insulator member 7 are axially stacked relative to axis X, with terminal 6 and part of collector 5 arranged on opposite (axial) sides of base plate 4.

More specifically, plate body 5a and terminal 6 are arranged on opposite sides of base plate 4.

Base plate 4 has a through hole 4a engaged by pin 5b, which then protrudes on the opposite side of base plate 4, in order to engage terminal 6, thereby establishing the electrical connection between collector 5 and terminal 6.

Conveniently, lid assembly 1 further comprises a stop frame 11 made of an electrically insulating material (such as rigid plastic), the function of which is known per se and not described in detail.

Base plate 4 may include a pour opening 12 through which the electrolytic solution is to be inserted.

Preferably, insulator member 7 is made of plastic material, in particular a rigid plastic material.

In the non-limiting embodiment shown, insulator member 7 is defined by a U-shaped body.

As shown in FIGS. 2a and 2b, the concave portion of insulator member 7 receives terminal 6, while the convex portion of insulator member 7 axially rests on base plate 4.

Alternatively, insulator member 7 may be flat or may have any other shape suitable for providing physical separation (and electrical insulation) between terminal 6 and base plate 4.

In practice, insulator member 7 defines an insulating gasket which electrically insulates terminal 6 from base plate 4.

Expediently, insulator member 7 has a central through hole for allowing the passage of pin 5b.

In order to assembly lid assembly 1, terminal 6 and collector 5 are compressed towards one another and towards base plate 4, according to a manner known.

Insulator member 7 is therefore axially compressed between terminal 6 and base plate 4.

As already specified in the introductory portion of the description, it is desirable that the electric insulation provided by the insulator member 7 is not complete, so as to avoid the aforementioned ESD phenomenon and allow a discharge of the parasitic currents.

Hence, insulator member 7 is made of a plastic material which is slightly conductive, so that an electric resistance of the insulator member 7 is comprised between 100 and 10000 ohms.

Usually, insulator member 7 is produced by injection molding the aforementioned plastic material in a known molding tool.

As a result of this process, an outer skin 7a may form on insulator member 7, which hinders the desired electrical conductivity by increasing the electric resistance thereof.

More specifically, as a result of the injection molding process, insulator member 7 has an inner portion 7b and an outer skin 7a surrounding inner portion 7b ad defining an external surface thereof.

For example, outer skin 7a may have a different material density than the material density of the inner portion 7a.

In greater detail, outer skin 7a may have a higher material density than the material density of the inner portion 7a, thereby determining said increase in electric resistance.

It is stated that in one embodiment outer skin 7a may have the same material density of inner portion 7b, thereby identifying a peripheral external portion of the insulator member 7.

Outer skin 7a is represented, for the sake of simplicity, as a uniform outer layer of insulator member 7. However, outer skin 7a may have a non-uniform thickness around inner portion 7b.

According to an aspect of the present invention, inner portion 7b of insulator member 7 includes at least one protrusion 13 projecting therefrom for piercing outer skin 7a, from the inside thereof, i.e. from the inside of outer skin 7a or of insulator member 7.

In particular, inner portion 7b of insulator member 7 includes at least one first protrusion 13 projecting towards and up to terminal 6 and at least one second protrusion 13 projecting towards and up to base plate 4, so that an electrical connection, or an “electric bridge”, is effectively established between terminal 6 and base plate 4 through insulator member 7 upon piercing of outer skin 7a.

More specifically, each protrusion 13 is configured to pierce outer skin 7a upon the compression of terminal 6 and collector 5 towards base plate 4, i.e. during assembly of lid assembly 1.

Thanks to the presence of protrusions 13, during assembly of lid assembly 1 the axial compression of the components determines the rupture of said outer skin 7a. In practice, protrusions 13 at least partially break open outer skin 7a.

In this way, in case an outer skin 7a forms due to the aforementioned injection molding production process of insulator member 7, the desired electric conductivity of insulator member 7 is ensured, since an electric bridge is repristinated between terminal 6 and base plate 4.

Electric resistance of insulator member 7 can therefore be maintained within the desired range defined by the material used for insulator member 7.

Conveniently, each protrusion 13 may be defined by a spike.

For example, inner portion 7b of insulator member 7 may comprise a plurality of spikes protruding therefrom, towards terminal 6 and/or towards base plate 4 (as shown in FIG. 1).

Alternatively, each protrusion 13 may be defined by a pointed rib, which may extend continuously or discontinuously along inner portion 7b.

Conveniently, each protrusion 13 extend in the axial direction, relative to axis X.

In this way, the Applicant observed that a more effective rupture of outer skin 7a following the axial compression is obtained.

Advantageously, inner portion 7b of insulator member 7 comprises a pair of said first protrusions 13 and a pair of said second protrusions 13.

That is, inner portion 7b comprises a pair, and particularly at least one pair, of protrusions 13 protruding from an axially upper surface of inner portion 7b towards terminal 6 and a pair, and particularly at least one pair, of protrusions 13 protruding from an axially lower surface of inner portion 7b towards base plate 4.

In this way, a structural stability of terminal group 8 is improved. Furthermore, unevenness between the interfaces of the components of terminal group 8 contacting one another is highly reduced, since production-related shape and positioning tolerances are compensated due to the presence of pairs of first and second protrusions 13. This further contributes to maintain the electric resistance (and therefore the electric conductivity) between terminal 6 and base plate 4 as much as possible within the desired range.

Conveniently, protrusions 13 are symmetrically distributed with respect to axis X, as shown in FIG. 2b. This further compensate shape and positioning errors.

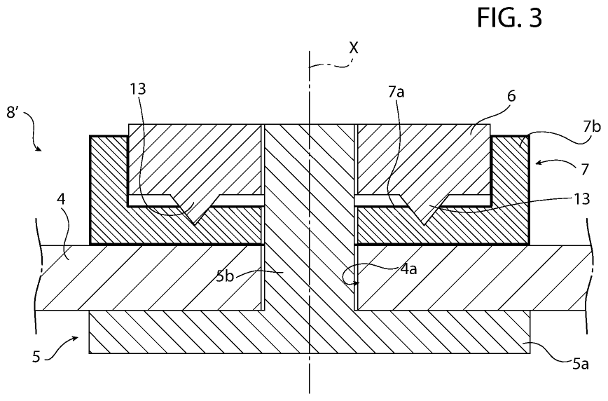

With reference to FIG. 3, number 8′ indicates as a whole a terminal group according to a second preferred embodiment of the present invention.

Since terminal group 8′ is similar, structurally and functionally, to terminal group 8, only the differences between them are described hereinafter, using where possible the same reference numbers for equal or corresponding parts.

In particular, terminal group 8′ differs from terminal group 8 in that the at least one protrusion 13 is carried by terminal 6, whereas insulator member 7 is devoid of protrusions 13.

That is, terminal 6 includes the protrusions 13.

In greater detail, terminal 6 includes protrusions 13 projecting towards insulator member 7 and piercing outer skin 7a from the outside thereof.

In this way, upon axial stacking and compression of terminal 6, collector 5, base plate 4 and insulator member 7, outer skin 7a is at least partially broken apart, So that the aforementioned electric bridge between terminal 6 and base plate 4 can be established.

Furthermore, unevenness and positioning errors between terminal 6 and insulator member 7 are reduced, thereby resulting in improved electric conductivity.

In this regard, the protrusions 13 on terminal 6 are symmetrically arranged with respect to axis X.

Preferably, protrusions 13 are made in one single piece with terminal 6.

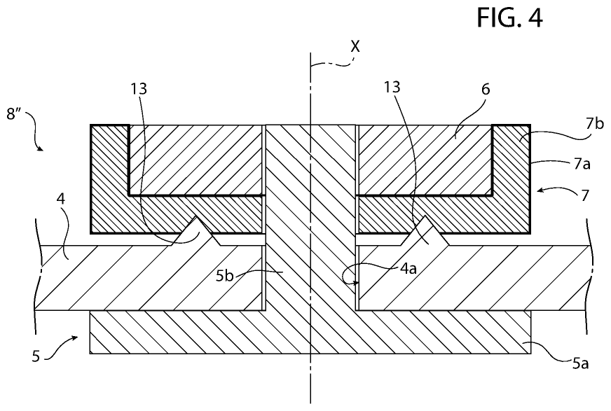

With reference to FIG. 4, number 8″ indicates as a whole a terminal group according to a second preferred embodiment of the present invention.

Since terminal group 8″ is similar, structurally and functionally, to terminal group 8′, only the differences between them are described hereinafter, using where possible the same reference numbers for equal or corresponding parts.

In particular, terminal group 8″ differs from terminal group 8′ in that the at least one protrusion 13 is carried by base plate 4. That is, base plate 4 includes the aforementioned at least one protrusion 13, whereas insulator member 7 and terminal 6 are devoid of protrusions 13.

In greater detail, base plate 4 includes protrusions 13 projecting towards insulator member 7 and piercing outer skin 7a from the outside thereof.

In this way, upon axial stacking and compression of terminal 6, collector 5, base plate 4 and insulator member 7, outer skin 7a is at least partially broken apart, So that the aforementioned electric bridge between terminal 6 and base plate 4 can be established.

Furthermore, unevenness and positioning errors between base plate 4 and insulator member 7 are reduced, thereby resulting in improved electric conductivity.

In this regard, the protrusions 13 on base plate 4 are symmetrically arranged with respect to axis X.

Preferably, protrusions 13 are made in one single piece with base plate 4.

According to a further preferred embodiment not shown, both terminal 6 and base plate 4 are provided with protrusions 13 projecting towards insulator member 7 and piercing outer skin 7a from the outside thereof, namely axially from above and from below.

The Applicant observed that this configuration ensures an even better piercing of outer skin 7a, thereby providing for a better electrical connection between terminal 6 and base plate 4.

In this case, caution must be taken in order to avoid a direct contact between the protrusions 13 of terminal 6 and the protrusions 13 of base plate 4, in order to avoid short circuit. In other words, it has to be ensured that inner portion 7b of insulator member 7 is interposed between these latter components.

In light of the foregoing, according to the present invention at least one among the inner portion 7b of insulator member 7, the terminal 6 and the base plate 4 includes at least one protrusion 13 projecting therefrom for piercing said outer skin 7a, respectively from the inside or from the outside thereof, i.e. from the inside or the outside of the outer skin 7a or the insulator member 7.

This is obtained thanks to the terminal groups 8, 8′ and 8″ according to the invention.

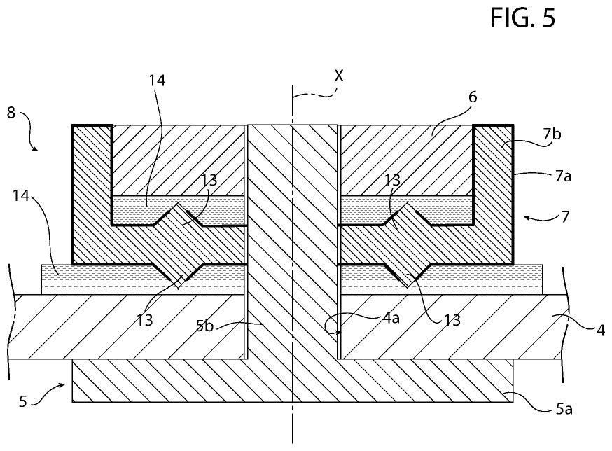

With reference to FIG. 5, terminal group 8 may further comprise at least one layer 14 of compressible and electrically conductive material.

In one embodiment, the at least one layer 14 is interposed between terminal 6 and insulator member 7.

In one embodiment, the at least one layer 14 is interposed between base plate 4 and insulator member 7.

Preferably, terminal group 8 includes two layers 14 of the aforementioned type, one layer 14 being interposed between terminal 6 and insulator member 7 and the other layer 14 being interposed between base plate 4 and insulator member 7.

Advantageously, each layer 14 comprises:
a sheet of gas diffusion layer, or “GDL”; or
a sheet of electrically conductive fleece; or
a fleece of carbon fibers; or
an elastomer-based gap pad.

Each layer 14 is axially compressed during the assembly of the lid assembly 1.

The compressibility of each layer 14 ensures that the aforesaid unevenness between the interfaces of the components is compensated.

Furthermore, possible air gaps between the components are eliminated, thereby further improving the desired electrical connection between terminal 6 and base plate 4.

Moreover, the aforesaid protrusions 13 are configured, upon said compression, to further pierce into each layer 14.

This further ensures that the aforesaid electrical connection is maintained as desired, so that parasitic currents which build up during use of the battery cell are effectively discharged.

In one embodiment, each layer 14 of compressible and electrically conductive material is defined by a coating/varnish (externally) applied to at least one among the insulator member 7, the terminal 6 and the base plate 4, so as to be interposed between terminal 6 and insulator member 7 and/or between insulator member 7 and base plate 4.

Conveniently, the coating/varnish has a thickness of 100 to 700 μm. The Applicant has empirically observed that such range provides for the optimal electric resistance between terminal 6 and base plate 4.

Conveniently, the coating/varnish is an elastomer-based coating/varnish.

The compressibility of the coating/varnish ensures that unevenness and air gaps are eliminated.

The use of a coating/varnish provides for an easier application of the layer 14, as well as the possibility for a partial application thereof.

Such partial application provides for a further parameter of adjustment of the electric resistance between terminal 6 and base plate 4, other than the materials and thickness chosen.

According to an alternative embodiment not shown, one of the terminal 6 and the base plate 4 may be at least partially overmolded with an electrically conductive elastomeric insert (not shown), which is interposed between said one of the terminal 6 and the base plate 4 and the other of the terminal 6 and the base plate 4, thereby defining said insulator member 7.

Accordingly, the elastomeric insert carries the aforesaid protrusions 13. Alternatively, one or both of the terminal 6 and the base plate 4 may carry the aforesaid protrusions 13.

In light of the foregoing description, it is clear how the present invention enables to implement a method for producing a lid assembly 1 for a prismatic battery cell, the method comprising the steps of:
a) providing a base plate 4, a current collector 5 electrically connectable to a respective electrode of the battery cell for collecting electrical energy therefrom, a terminal 6 electrically couplable with the current collector 5 for receiving the electrical energy therefrom, and an insulator member 7 having an inner portion 7b and an outer skin 7a surrounding the inner portion 7b and defining an external surface thereof;
b) stacking the terminal 6, the insulator member 7, the base plate 4 and the collector 5 on top of each other, so that the insulator member 7 is interposed between the terminal 6 and the base plate 4, and the terminal 6 and at least part of the collector 5 are arranged on opposite sides of the base plate 4;
c) compressing the terminal 6 and the current collector 5 towards the base plate 4;
d) piercing the outer skin 7a of the insulator member 7, respectively from the inside or from the outside thereof, by means of at least one protrusion 13 carried by one among the inner portion 7b of the insulator member 7, the terminal 6 and the base plate 4;
wherein the step d) of piercing is carried out by means of the step c) of compressing.

The advantages of lid assembly 1, and of the related method, according to the present invention will be clear from the foregoing description.

In particular, thanks to the presence of the protrusions 13 which pierce and break open outer skin 7a (or the external surface of insulator member 7) upon compression of the components of terminal group 8, 8′, 8″, a stable and effective electric connection between terminal 6 and base plate 4 (of the cathode) can be ensured, through insulator member 7 and with the desired electric resistance (preferably 100-10000 ohms), and removing any hindering to such electric connection.

Moreover, any unevenness and/or positioning error and/or air gap between the interfaces of the adjoining and axially stacked components of terminal group 8, 8′, 8″ is substantially reduced, and at limit avoided, so that the electric resistance is kept in the desired range.

Furthermore, the presence of any layer 14 of compressible and electrically conductive material further improves the desired electrical connection between terminal 6 and base plate 4.

In case a coating/varnish is used as layer 14, it provides for an easier application thereof, as well as the possibility for a partial application thereof. Such partial application provides for a further parameter of adjustment of the electric resistance between terminal 6 and base plate 4, other than the materials and thickness chosen.

Clearly, changes may be made to lid assembly 1 as described herein without, however, departing from the scope of protection as defined in the accompanying claims.

For example, casing 2 may comprise two openings 3a (a top opening and a bottom opening, or a left opening and a right opening) opposite to one another. In this case, two lid assemblies 1 respectively close the two openings 3a, and each lid assembly 1 includes only one terminal group 8, 8′, 8″, wherein each of such terminal groups defines an anode terminal group or a cathode terminal group. Accordingly, the cathode terminal group would include protrusions 13 according to the present invention and possibly layers 14.

Furthermore, in one embodiment not shown, lid assembly 1 may include only the aforementioned one or more layers 14 of compressible and electrically conductive material, while the inner portion 7b of insulator member 7, terminal 6 and base plate 4 are devoid of any protrusion 13. The Applicant has in fact observed that such a configuration may provide, in some cases, for a sufficient discharge of the aforementioned parasitic currents.

1. A lid assembly for a prismatic battery cell comprising:
a base plate for closing an inner compartment of the battery cell;
at least one current collector electrically connectable to a respective electrode of the battery cell, for collecting electrical energy and transferring it from the inner compartment outwards;
at least one terminal electrically coupled with the current collector for receiving the electrical energy therefrom; and
an insulator member (interposed between the terminal and the base plate for electrically insulating the terminal (6) from the base plate;
wherein the insulator member has an inner portion and an outer skin surrounding the inner portion and defining an external surface thereof;
and wherein at least one among the inner portion of the insulator member, the terminal and the base plate includes at least one protrusion projecting therefrom for piercing said outer skin, respectively from the inside or from the outside thereof.

2. The lid assembly as claimed in claim 1, further comprising a terminal group which includes said collector, said terminal and said insulator member and which has a central axis,
wherein the base plate, the terminal, the collector and the insulator member are axially stacked relative to said axis,
and wherein said protrusion extends in the axial direction.

3. The lid assembly as claimed in claim 1, wherein the terminal and at least part of the collector are arranged on opposite sides of the base plate and are compressed towards one another and towards the base plate;
and wherein said protrusion is configured to pierce said outer skin upon compression of the terminal and the collector towards the base plate.

4. The lid assembly as claimed in claim 1, wherein the inner portion of the insulator member includes at least one first protrusion projecting towards and up to the terminal and at least one second protrusion projecting towards and up to the base plate, so that an electrical connection is established between the terminal and the base plate through the insulator member upon piercing of said outer skin.

5. The lid assembly as claimed in claim 4, wherein the inner portion of the insulator member comprises a pair of said first protrusions and a pair of said second protrusions.

6. The lid assembly as claimed in claim 1, wherein the terminal and/or the base plate include said protrusion projecting towards the insulator member and piercing said outer skin from the outside thereof.

7. The lid assembly as claimed in claim 1, wherein said at least one protrusion is defined by a spike or by a pointed rib.

8. The lid assembly as claimed in claim 1, further comprising one or more layers of compressible and electrically conductive material, which one or more layer are interposed between the terminal and the insulator member and/or between the insulator member and the base plate.

9. The lid assembly as claimed in claim 8, wherein each said layer comprises:
a sheet of gas diffusion layer; or
a sheet of electrically conductive fleece; or
a fleece of carbon fibers; or
an elastomer-based gap pad.

10. THe lid assembly as claimed in claim 8, wherein each said layer of compressible and electrically conductive material is defined by a coating/varnish applied to at least one of the insulator member, the terminal and the base plate, so as to be interposed between the terminal and the insulator member and/or between the insulator member and the base plate.

11. The lid assembly as claimed in claim 10, wherein the coating/varnish has a thickness of 100 to 700 μm.

12. The lid assembly as claimed in claim 10, wherein the coating/varnish is an elastomer-based coating/varnish.

13. The lid assembly as claimed in claim 8, wherein said at least one protrusion is configured to further pierce into said layer of compressible and electrically conductive material.

14. The lid assembly as claimed in claim 1, wherein one of the terminal and the base plate is at least partially overmolded with an electrically conductive elastomeric insert, which is interposed between said one of the terminal and the base plate and the other of the terminal and the base plate, thereby defining said insulator member.

15. A method for producing a lid assembly for a prismatic battery cell, the method comprising the steps of:
a) providing a base plate, a current collector electrically connectable to a respective electrode of the battery cell for collecting electrical energy therefrom, a terminal electrically couplable with the collector for receiving the electrical energy therefrom, and an insulator member having an inner portion and an outer skin surrounding the inner portion and defining an external surface thereof;
b) stacking the terminal, the insulator member, the base plate and the collector on top of each other, so that the insulator member is interposed between the terminal and the base plate, and the terminal and at least part of the collector are arranged on opposite sides of the base plate;
c) compressing the terminal and the collector towards the base plate;
d) piercing the outer skin of the insulator member, respectively from the inside or from the outside thereof, by means of at least one protrusion carried by one among the inner portion of the insulator member, the terminal and the base plate;
wherein the step d) of piercing is carried out by means of the step c) of compressi
